(19) United States
(12) Patent Application Publication
(10) Pub. No.: US 2016/0292625 A1
(43) Pub. Date: Oct. 6, 2016

(54) PRODUCT DATA ANALYSIS

(71) Applicant: HEWLETT- PACKARD DEVELOPMENT COMPANY, L.P., Houston, TX (US)

(72) Inventors: Cara J. Curtland, Vancouver, WA (US); Brad David Wolf, Roseville, CA (US); Jerry Hwang, Cupertino, CA (US)

(21) Appl. No.: 15/035,564

(22) PCT Filed: Nov. 15, 2013
(86) PCT No.: PCT/US13/70450

§ 371 Date: Jun. 29, 2016

(51) Int. Cl. G06Q 10/08; G06T 11/20; G06F 3/0481; G06F 3/0484; G06F 17/24

(52) U.S. Cl. CPC G06Q 10/087; G06F 3/04842; G06F 17/245; G06F 3/0481; G06F 3/04847; G06T 11/206

(57) ABSTRACT

An example method for analyzing product data in accordance with aspects of the present disclosure includes receiving a selection of a product from a user, obtaining data associated with the product, providing visual analysis of the data, and presenting a recommendation based on the data. The data comprises at least different types of a parameter.

### BACKGROUND

Inventory optimization is important for retail businesses involved with the sale of finished goods and products as well as for manufacturing businesses that produce finished goods, products and/or components for use in other goods and products. The management of the inventory may be based on several variables and targets, including budgetary targets, product priorities, and inventory costs.

### BRIEF DESCRIPTION OF THE DRAWINGS

Example implementations are described in the following detailed description and in reference to the drawings, in which:

FIG. 1 illustrates an example system diagram in accordance with various examples;

FIG. 2 illustrates an example of an inventory prioritization and categorization system in accordance with various examples;

FIG. 3 illustrates a user interface according to one example usable with a display module of the example system of FIG. 1;

FIG. 4 illustrates a component of the user interface of FIG. 3 in accordance with various examples;

FIG. 5 illustrates a component of the user interface of FIG. 3 in accordance with various examples;

FIG. 6 illustrates a component of the user interface of FIG. 3 in accordance with various examples;

FIG. 7 illustrates a component of the user interface of FIG. 3 in accordance with various examples;

FIG. 8 is an example plot illustrating inventory forecasting in accordance with various examples;

FIG. 9 is an example plot illustrating inventory forecasting in accordance with various examples;

FIG. 10 is an example plot illustrating inventory forecasting in accordance with various examples; and

FIG. 11 illustrates an example method in accordance with various examples.

### DETAILED DESCRIPTION

Various implementations described herein are directed to inventory optimization. More specifically, and as described in greater detail below, various aspects of the present disclosure are directed to a manner by which a set of processes are implemented using a platform to allow a business to optimize end to end inventory, control cash flow, and minimize cyclical behavior in working capital throughout the quarter.

Aspects of the present disclosure described herein implement a comprehensive and integrated tool that allows inventory management and intelligent decision making. Inventory optimization requires balancing capital investment constraints or objectives and service-level goals over a large assortment of stock-keeping units (SKUs) while taking demand and supply volatility into account. Organizations can manage data on millions of SKUs, gather and consolidate huge data volumes throughout the distribution chain, then transform, standardize and cleanse the data for inventory optimization. Also, in order to maximize the outcome of product-related decisions, retail store and supplier management may use statistical modeling and strategic planning to optimize the decision making process for many product decisions. Among other things, this approach allows the user utilize such tools to achieve these goals.

Moreover, aspects of the present disclosure described herein also allow the user to assess the performance of their parts and take action. Among other things, this approach allows the user to control increased free cash flow and lower working capital requirements.

In one example in accordance with the present disclosure, a method for analyzing product data is provided. The method comprises receiving a selection of a product from a user, obtaining data associated with the product, providing visual analysis of the data, and presenting a recommendation based on the data. The data comprises at least different types of a parameter, and the user selects a type from the different types of the parameter based on the recommendation.

In another example in accordance with the present disclosure, a system is provided. The system comprises a data capturing module to collect data associated with a product, the product selected by a user and the data comprising at least one of a plurality of product inventory levels, a display module to provide visual analysis of the data, the display module controlling a plurality of display regions, wherein a first of the plurality of display regions includes at least one graphical representation, and a second of the plurality of display regions includes a plurality of cells, and wherein the first and second of the plurality of display regions represent the at least one of a plurality of inventory levels, and a recommendation module to provide a recommendation related to the at least one of the plurality of product inventory levels.

In a further example in accordance with the present disclosure, a non-transitory computer-readable medium is provided. The non-transitory computer-readable medium comprises instructions that when executed cause a device to (i) obtain data associated with a product selected by a user, the data comprising at least different types of a parameter, (ii) provide visual analysis of the data, (iii) present a recommendation based on the data, wherein the user selects a type from the different types of the parameter based on the recommendation, and (iv) update the data based on the type of the parameter selected by the user.

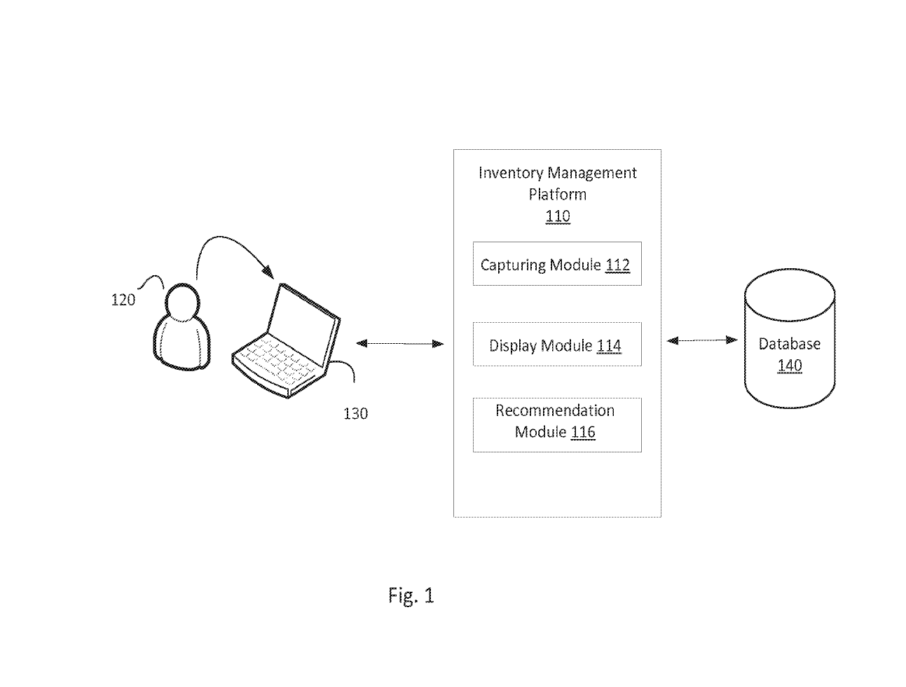

FIG. 1 illustrates an example inventory optimization platform 110 in accordance with an implementation. The inventory optimization platform 110 is a part of an inventory optimization system, and the platform 110 comprises a data capturing module 112, display module 114, and recommendation module 116, each of which is described in greater detail below. It should be readily apparent that the platform 110 illustrated in FIG. 1 represents a generalized depiction and that other components may be added or existing components may be removed, modified, or rearranged without departing from a scope of the present disclosure. Moreover, although the various modules 112-116 are shown as separate modules in FIG. 1, in other implementations, the functionality of all or a subset of the modules 112-116 may be implemented as a single module.

The inventory optimization platform 110 may use supply chain management concepts to efficiently display the product inventory levels and contribute to the inventory optimization system's management of the product inventory levels to satisfy a number of factors. These factors may include, but not limited to, stock level targets, budgetary constraints, profit margins, product volume, and revenue.

The platform 110 illustrates a tool for a user of the system (e.g., a planner) to quickly assess the performance of various parts and take action. The platform 110 may perform tasks involving, but not limited to, reviewing target days of stock (TDOS) for at least one part (e.g., product, part of a product), setting re-order point (ROP), and viewing all relevant part attributes and buffer projection. This information may be based on actual historical usage data and/or forecasted data (e.g., sales growth forecasts). Accordingly, the platform 110 considers a plurality of ROP types and recommends one of the plurality of ROP types to the user in order to manage availability of supply to meet established service levels. Moreover, the system and techniques disclosed herein analyze historical production and/or consumption data and/or forecast data for a component and conduct one or more mathematical analyses. Resulting analyses generate various graphical views and tables related to target inventory levels that may ensure there is enough material on hand and/or on order to meet a specified service level.

The service level may be defined as the percent of time that a customer's request for a product may be satisfied from stock. The service level may be chosen depending on how willing a company may be to satisfy a customer's request for a product. This may affect stock levels and cost of inventory since a high service level may increase the amount of stock required to be kept, which may directly affect the overall costs to the company.

In one implementation, the part may comprise a product being sold or managed by the planner. Further, part information may include various attributes and data concerning a plurality of products. The data associated with each product may include a point of re-order value, an assigned category by the planner, and a plan of record. The various attributes and data in various combinations may be used by the platform 110 in presenting inventory and safety stock targets. Additional data about the products may include forecast and consumption demands, delivery times for each product and an associated variability in the delivery times, and other basic product information (number, line, location, platform, etc.).

In FIG. 1, the platform 110 is shown as a stand-alone system and connected to a computing device 130, which is used by the user 120. In some implementations, the platform 110 may be incorporated into the computing device 130.

In one implementation, the platform 110 may comprise the capturing module 112. The capturing module 112 collects inventory data from various components of inventory optimization system, which the platform 110 is a part of. The inventory data may be used to derive further analysis by applying a set of algorithms.

The display module 114 comprises the inventory data being displayed at a graphical view or widget. Multiple widgets may be displayed on a dashboard screen of the user, for use in managing inventory. The display module 114 display inventory optimization information to the user and allows the user to interact with the platform 110 to make selections or changes.

The recommendation module 116 may derive further analysis by applying a set of algorithms, and based on certain data, may recommend, for example, an ROP type (e.g., forecast or consumption based ROP). In one implementation, the user may choose to change certain data via the platform 110 based on the recommendation received from the recommendation module 116. In such implementation, the platform 110 may comprise an additional module (e.g., revision module), which saves changed data resulting from the recommendation provided by the recommendation module 116.

In one implementation, the computing device 130 may be in the form of any portable, mobile, or hand-held electronic device, such as a laptop, a notebook, a tablet device, a personal digital assistant (PDA), or a mobile phone. The computing device 130 may include a processor (e.g., central processing unit) and a computer memory (e.g., RAM). The computer memory may store data and instructions and the processor executes instructions and processes data from the computer memory. The processor may retrieve instructions and other data from storage device (e.g., hard drive) before loading such instructions and other data into the computer memory. The processor, computer memory and storage device may be connected by a bus in a conventional manner.

In one implementation, consistent with the present disclosure, a display may be a part of the electronic device 130. In another implementation, the display may be a stand-alone unit, separate from the electronic device 130. The electronic device 130 and/or the platform 110 (more specifically, the display module 114) may be coupled to the external display, for outputting a display signal to the display. In such implementation, the display may be connected to the electronic device 130 and/or the platform 110 through any type of interface or connection, including 12C, SPI, PS/2, Universal Serial Bus (USB), Bluetooth, RF, IRDA, keyboard scan lines or any other type of wired or wireless connection to list several non-limiting examples.

The display may refer to the graphical, textual and auditory information the platform 110 may present to the user 120, and the control sequences (e.g., keystrokes with the keyboard) the user 120 may employ to control the platform 110. In some implementations, the user 120 may interact with the electronic device 130 by a plurality of input devices, such as a keyboard, mouse, touch device, or verbal command. For example, the user 120 may control a keyboard, which may be an input device for the platform 110. The electronic device 130 may help translate input received by the keyboard. The user may perform various gestures on the keyboard. Such gestures may involve, but not limited to, touching, pressing, waiving, placing an object in proximity.

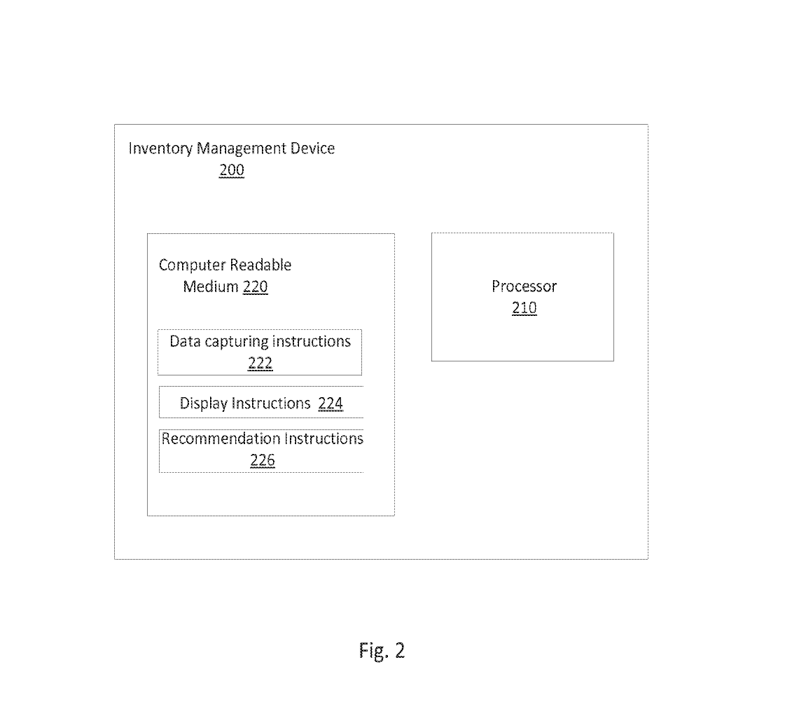

FIG. 2 illustrates example block diagram of the architecture of the system 200 in accordance with an implementation. It should be readily apparent that the system 200 illustrated in FIG. 2 represents a generalized depiction and that other components may be added or existing components may be removed, modified, or rearranged without departing from a scope of the present disclosure. The system 200 comprises a processor 210 and a computer readable medium 220. The computer readable medium 220 comprises data capturing instructions 222, display instructions 224, and recommendation instructions 226.

In one implementation, the processor 210 may be in data communication with the computer readable medium 220. The processor 210 may retrieve and execute instructions stored in the computer readable medium 220. The processor 210 may be, for example, a central processing unit (CPU), a semiconductor-based microprocessor, an application specific integrated circuit (ASIC), a field-programmable gate array (FPGA) configured to retrieve and execute instructions, other electronic circuitry suitable for the retrieval and execution instructions stored on a computer readable storage medium, or a combination thereof. The processor 210 may fetch, decode, and execute instructions stored on the storage medium 220 to operate the device in accordance with the above-described examples. As an alternative or in addition to retrieving and executing instructions, the processor 210 may include at least one integrated circuit (IC), other control logic, other electronic circuits, or combinations thereof that include a number of electronic components for performing the functionality of instructions stored on the storage medium 220. Accordingly, the processor 310 may be implemented across multiple processing units and instructions stored on the storage medium 220 may be implemented by different processing units in different areas of the user device 300.

The computer readable medium 220 may be a non-transitory computer-readable medium that stores machine readable instructions, codes, data, and/or other information. In certain implementations, the computer readable medium 220 may be integrated with the processor 210, while in other implementations, the computer readable medium 220 and the processor 210 may be discrete units.

In one implementation, the computer readable medium 220 may include program memory that includes programs and software such as an operating system, user detection software component, and any other application software programs. Further, the computer readable medium 220 may participate in providing instructions to the processor 210 for execution. The computer readable medium 220 may be one or more of a non-volatile memory, a volatile memory, and/or one or more storage devices. Examples of non-volatile memory include, but are not limited to, electronically erasable programmable read only memory (EEPROM) and read only memory (ROM). Examples of volatile memory include, but are not limited to, static random access memory (SRAM) and dynamic random access memory (DRAM). Examples of storage devices include, but are not limited to, hard disk drives, compact disc drives, digital versatile disc drives, optical devices, and flash memory devices.

The instructions 222, 224, 226, stored on the storage medium 220, when executed by processor 210 (e.g., via one processing element or multiple processing elements of the processor) can cause processor 210 to perform processes, for example, the processes depicted herein.

Data capturing instructions 222 may cause the processor 210 to retrieve data associated with a product, which is identified by the user. Display instructions 224 may cause the processor 310 to provide visual analysis of the data. More specifically, the display instructions 224 may comprise instructions to control a plurality of display regions. A first of the plurality of display regions may include at least one graphical representation. Moreover, a second of the plurality of display regions includes a plurality of tables (e.g., cells). Accordingly, the first and second of the plurality of display regions provide visual information related to the inventory levels of the product.

Recommendation instructions 226 may cause the processor 310 to present at least one recommendation to the user. The recommendation may be related to a parameter associated with the data. For example, the system may recommend that the user selects a specific type of an ROP. The system may review forecast value add (FVA) value of the product and determine what type of ROP is the best fit for the product. In one example, the system may determine that the FVA is 0 or greater, and the system may recommend using forecast based ROP. In another example, the system may determine that the FVA is less than 0, but that the consumption based ROP does not cover the forecast value. Accordingly, the system may recommend using forecast based ROP. In a further example, the system may determine that the FVA is less than 0, and the consumption based ROP covers the forecast value. Thus, the system may recommend using consumption based ROP. In various implementations, the user follows the recommendation presented by the system unless there is a valid reason (e.g., valid business driver) for not following the recommendation.

In one implementation, the computer readable medium 220 may have a plurality of databases, including, but not limited to, a planner profile database. The planner profile database may store planner profile data such as planner identification data, planner interface data, and profile management data and/or the like.

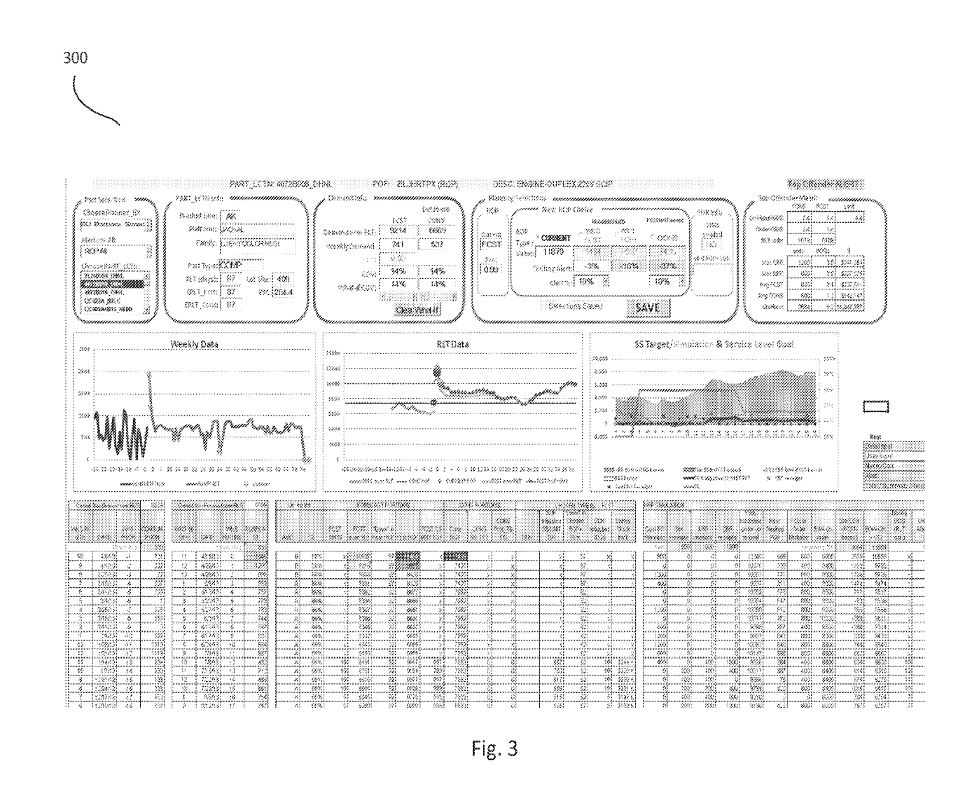

FIG. 3 illustrates example a user interface 300 of the inventory optimization platform 110 of FIG. 1 in accordance with an implementation. One implementation of the user interface 300 usable as part of the display module (i.e., the display module 114 as shown in FIG. 1 may be called a planner dashboard. The user interface 300 may include any appropriate number of portions or regions (e.g., display regions) each of which may be operable to convey various types of information to a user and/or allow the user to interact with the user interface 300. For instance, the user interface 300 may include a plurality of tables and plots. In particular, the user interface 300 may include various textual and numerical information and/or data related to one or more components or end items that may be appropriately manipulated by a user. Further, the user interface 300 may include one or more graphical representations (e.g., line graphs) related to one or more selected components or end items corresponding at least in part to the information located in the other parts (e.g., tables) of the user interface 300.

In one implementation, the inventory optimization system may require that authentication information for a user to be able to view and control the planner dashboard. More specifically, an authorized individual may be required to enter information, such as a user ID/password of the authorized individual.

In one implementation, inputs for the planner dashboard illustrated with the user interface 300 comprise suggested replenishment lead time (RLT), ROP type, TDOS, prior single-use kanban (SUK) entries, forecast value add, current forecast, consumption history related to at least one part (e.g., product, part of a product). All of the inputs to the user interface 300 may be contained in a single database or may be compiled from several databases distributed across an organization and connected via a network, such as a wide area network (WAN), a storage area network (SAN), or in various data servers connected to the internet.

In one implementation, the ROP types may comprise forecast based ROP (i.e., forecast ROP) and historical consumption based ROP (i.e., consumption ROP). ROP may be determined by the sum of demand over RLT and safety stock. For example, a forecast ROP may be calculated as the sum of the forecast for the period of days equal to the RLT+TDOS, beginning with the week the forecast ROP is attributed to.

A consumption ROP, may be calculated by dividing the CONS Demand over RLT (as further described below) by the RLT, resulting in a daily consumption rate. That daily consumption rate can then be multiplied by the RLT+TDOS number of days.

A target days of stock (TDOS) level or an inventory target for a product may be influenced by many factors. In some implementations, TDOS may be defined as an additional supply being requested (pulled forward) to cover forecast and supply variability. TDOS may be calculated by using the following equation:

TDOS=k*RLT*CoV,

wherein k stands for a parameter of a standard normal distribution, which varies based on a chosen service level. The standard normal distribution may also define a relationship between the percentages of RLT periods with the chosen service level demand. RLT is measured in days and includes entire order-to-delivery period. The RLT may include its own confidence, such as 90%. The confidence, however, may change with supplier and or product based on experience. In another implementation, the RLT may be substituted with effective replenishment lead time (ERLT), which may include some additional lead time. More specifically, ERLT includes an entire order-to-delivery period and additional effective lead time due to limited supplier response capability outside of the replenishment lead time. The additional lead time may be calculated based on the product's CoV and any known supplier response parameters or factory operating guidelines.

Further, CoV is the coefficient of variation. In one implementation, a consumption based TDOS may be calculated, and in such implementation, a coefficient of variation of cumulative consumption over RLT (CoVcCONS) parameter may be used, which would be based on RLT variations of past consumption-based forecasts relative to actual consumption of the product. Alternatively, in another implementation, a forecast based TDOS may be calculated, and in such implementation, a coefficient of variation of cumulative forecast error over RLT (CoVcFE) parameter may be used. The CoV parameter represents the ability of the Enterprise to accurately predict consumption over the replenishment leadtime (RLT) of a product. A CoV of 0 would mean a perfect prediction, whereas larger values indicate less accurate forecasting capabilities.

In some implementations, the planner dashboard displays alerts for the user to review, and provide SKU (stock keeping unit)-level simulations. Further, the planner dashboard may allow the user to evaluate incremental consumption history and historical forecast, ROP alerts for change, UK plans, TDOS coverage. Moreover, the planner dashboard may allow the user to set ROP type and value and enter SUKs. When the user make changes on the data displayed on the planner dashboard, such changes may be posted to a database.

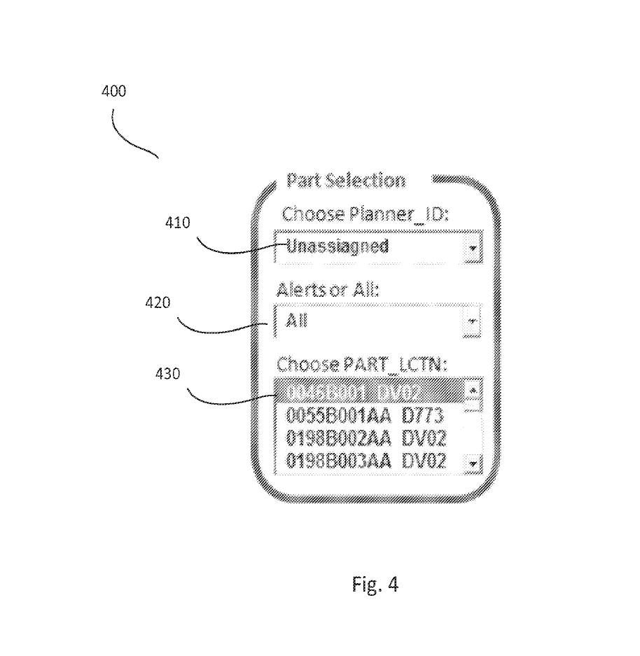

FIG. 4 illustrates a part selection component 400 of the planner dashboard 300 of FIG. 3 in accordance with an implementation. It should be readily apparent that the part selection component 400 illustrated in FIG. 4 represents a generalized depiction and that other components may be added or existing components may be removed, modified, or rearranged without departing from a scope of the present disclosure. For example, the part selection component 400 comprises of three dropdown menus. While the part selection component 400 illustrated in FIG. 4 includes three dropdown menus, the system may actually comprise less or more dropdown menus, and only three has been shown and described for simplicity.

Starting with the part selection component 400, the user may assess the health of various parts and take necessary actions via the planner dashboard. In one implementation, the user may choose a planner_ID using the Choose Planner_ID menu 410 to filter the part/locations displayed to show only those assigned to the selected planner. More specifically, the list of parts may be generated based on the user ID. For example, when the user selects the ID, the parts associated with that ID are displayed in the list.

The Alerts or All 420 comprises four types of alter filters, ROP alert, ROP alert may apply to parts requiring ROP with suggested changes outside the Alert Threshold. ROP All displays all parts requiring ROP, regardless of alert threshold values. NRP displays all parts requiring TDOS, excluding those requiring ROP. All shows all parts requiring ROP or TDOS. Moreover, the user defines what part to be analyzed by selecting the part number under the choose PART_LCTN menu 430.

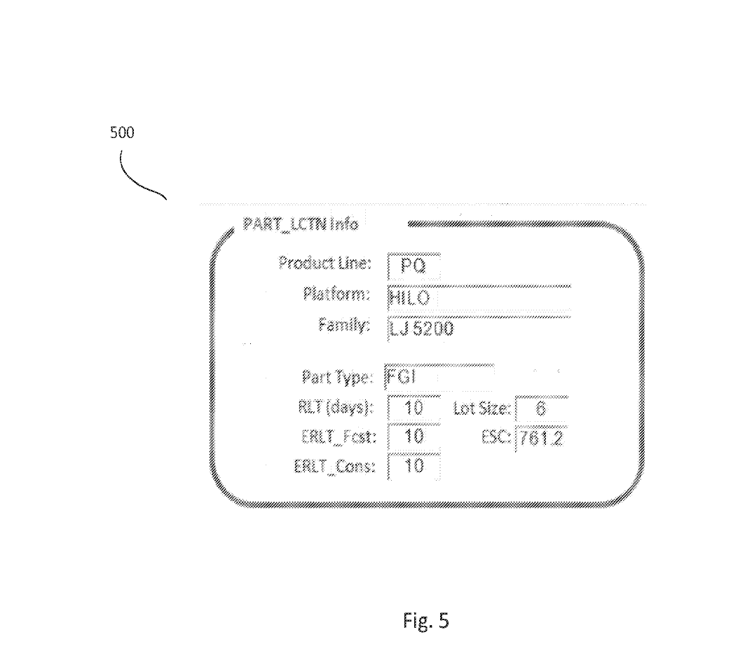

FIG. 5 illustrates a part location information component 500 of the planner dashboard 300 of FIG. 3 in accordance with an implementation. It should be readily apparent that the part location information component 500 illustrated in FIG. 5 represents a generalized depiction and that other components may be added or existing components may be removed, modified, or rearranged without departing from a scope of the present disclosure.

The part location information component 500 comprises a plurality of fields, including product line, platform and family. Moreover, the part location information component 500 comprises party type field. The part type one of a plurality of descriptions, including COMP (component) or FGI (Finished Goods Inventory). In addition, RLT (Replenishment Lead Time), Lot Size. ESC (Enterprise Standard Cost) are displayed. All fields in component 500 are attributes of the specific part selected in the part selection component 400 as shown in FIG. 4.

Both types of ERLT calculated based on FOG (factory operating guidelines). In particular, ERLT_Fcst uses forecast COV and represents effective replenishment lead time considering factory order guideline (FOG) constraints. In some implementations, ERLT_Fcst may be greater or equal to RLT. ERLT_Cons uses consumption COV and represents effective replenishment lead time considering factory order guideline (FOG) constraints. In some implementations, ERLT_Cons may be greater or equal to RLT.

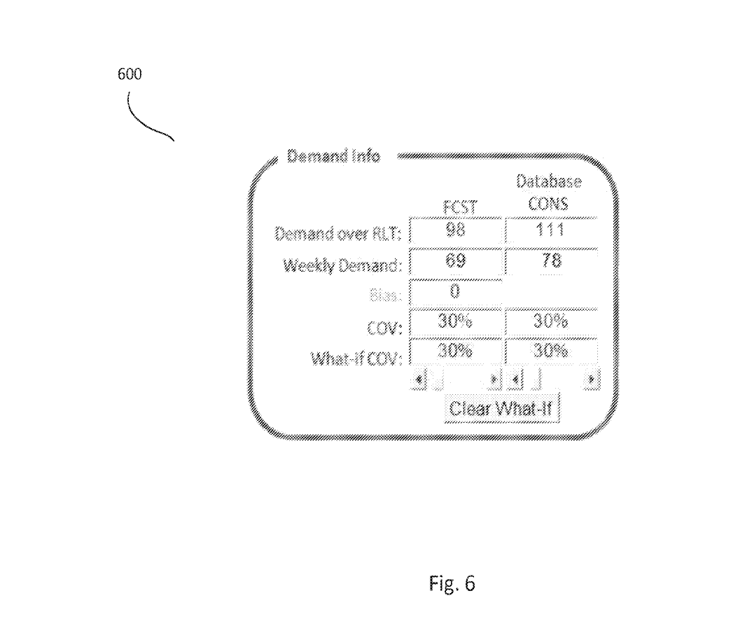

FIG. 6 illustrates a demand information component 600 of the planner dashboard 300 of FIG. 3 in accordance with an implementation. It should be readily apparent that the demand information component 600 illustrated in FIG. 6 represents a generalized depiction and that other components may be added or existing components may be removed, modified, or rearranged without departing from a scope of the present disclosure.

The demand information component 600 comprises data related to forecast (FCST) based information and consumption (CONS) based information. For example, Demand over the RLT period has two values, one based on forecast and the other one based on historical consumption. More specifically in FIG. 6, FCST is the sum of current demand over RLT, starting in week 1. CONS is the average of RLT consumption over a specified period. In one implementation, the period chosen to calculate the CONS Demand over RLT may be 3 months.

Moreover, the demand information component 600 comprises weekly demand. Average Weekly Demand may be calculated using the following equation:

Average Weekly Demand=(Demand over RLT)/(RLT Days*7)

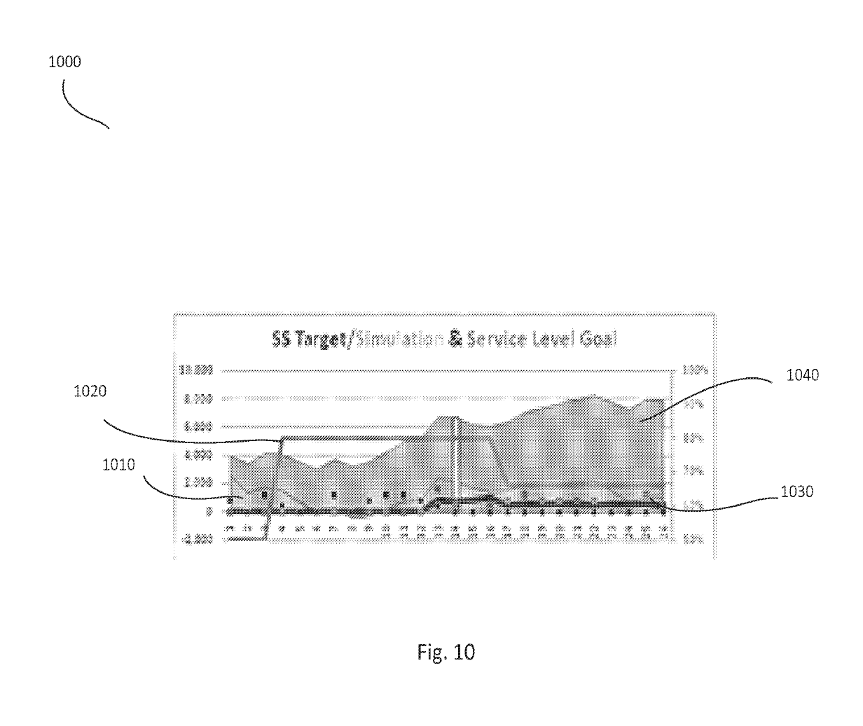

Further, the demand information component 600 comprises a coefficient of variation (COV) and What-if COV, which is used to allow the user to analyze changes in COV. In some implementation, the user may also analyze impacts of the change in the COV For example, a change in the COV will impact the calculated TDOS. An increase in COV causes an increase in TDOS and will result in a higher predicted inventory buffer. The magnitude of the change in buffer may be seen by the user in the graphical representation of the projected inventory buffer depicted in FIG. 10. What-if analysis enables analysis of past data along with giving anticipations of future trends by enabling the user to simulate and inspect the behavior of a complex system under some given hypotheses. What-if analysis is a data-intensive simulation measuring how changes in a set of independent variables impact on a set of dependent variables with reference to a simulation model offering a simplified representation of the business, designed to display significant features of the business and tuned according to the historical enterprise data.

In one implementation, the user may choose to click on Clear What-If button to remove any what-if COV values. When the what-if COV values are removed, the planner selections may be saved as what-if scenarios cannot be saved. In another implementation, the what-if scenario values may be saved and used for additional analysis.

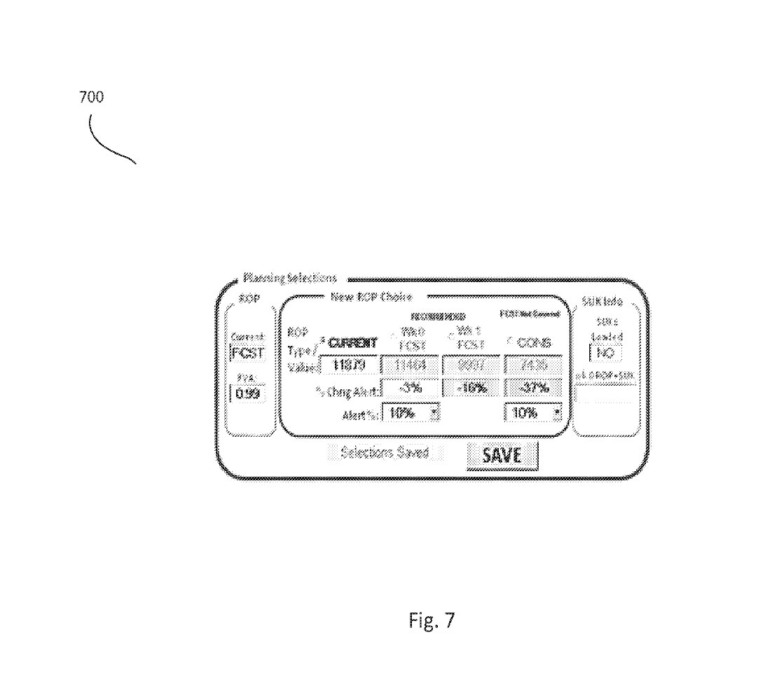

FIG. 7 illustrates examples of planning selection component 710, respectively, in accordance with an implementation. It should be readily apparent that the planning selection component 710 illustrated in FIG. 7 represents generalized depictions and that other components may be added or existing components may be removed, modified, or rearranged without departing from a scope of the present disclosure.

As discussed earlier, the ROP type may be forecast or historical consumption. In the example illustrated in FIG. 7, the current ROP type is set to forecast (FCST). Moreover, FVA (forecast value add) value displayed on the planning selection component 710 is 0.99, which is related to the ROP type. More specifically, based on the FVA value, the inventory optimization system may recommend Forecast or Consumption based ROP. For example, an FVA value that is equal to or greater than 0 indicates that forecast as the ROP type is a better choice for the inventory optimization system, and an FVA value that is less than 0 indicates that consumption as the ROP type is a better choice.

The forecast ROP may be determined by analyzing forecast data points (e.g., component usage data indicative of forecasted consumption) for the particular component to establish a base inventory amount. For example, after determining the appropriate supplier lead-time for the particular component (e.g., 4 weeks), an average component forecast (e.g., sales forecast) may be calculated in the same units as the determined supplier lead-time (e.g., weekly average). Thereafter, the base inventory amount may be determined by multiplying the average component forecast by the supplier lead-time. The statistical inventory amount may be ascertained using non-adjusted lead-time. The base inventory amount and the statistical inventory amount may then be added together to obtain the Forecast ROP or target inventory level.

In FIG. 7, the planning selection component 710 comprises a new ROP choice component, which acts as a recommendation engine assisting the user. The new ROP choice component displays values for the two ROP types (e.g., FCST and CONS) in addition to the current ROP type. Further, the FCST ROP type may be shown as WK0 FCST or WK1 FCST where the WK0 FCST value is calculated using the forecast over leadtime plus TDOS days starting with the current week's forecast and WK1 FCST is calculated using the forecast over leadtime plus TDOS days starting with next week (i.e., excluding WK0 from the calculated value). The forecast and consumption ROP values are calculated based on most recent data (forecast, consumption, COV, etc.). For example, the value for the current ROP type is 11879, the value for the WK0 FCST is 11464, the value for WK1 FCST is 9997, and the value for the CONS is 7435. Further, the recommendation engine provides a recommendation for the user's consideration based on the values.

In one implementation, the new ROP choice component comprises change alerts (e.g., % Chng Alert) showing the difference in percentage between current ROP and the values of the new ROP selection options (e.g., WK0 FCST, WK1 FCST, and CONS). In one implementation, the percentage may be highlighted in red indicating that a change is necessary if the change between the current value and the value of a ROP type is over a predetermined threshold. For example, the threshold may be set to 10%, as illustrated as Alert %. In various implementations, the user may change the alert threshold to a different number, and may define different threshold values for the different ROP types). Accordingly, when the change between the values is more than 10% (e.g., higher than +10% or less than −10%), the inventory optimization system may alert the user by highlighting the numbers in red for the % Chng Alert boxes.

In one implementation, the new ROP choice component illustrates the recommended ROP type for the user's consideration. More specifically, as described earlier, the recommendation engine recommends an ROP type to the user based on the FVA value calculated by the inventory optimization system. For example, if the FVA value is equal to or greater than 0, the recommendation engine recommends forecast as the ROP type, and if the FVA value is less than 0, the recommendation engine recommends consumption as the ROP type. The recommended ROP type may be marked with the text “recommended,” and the user may select the recommended ROP type by clicking on it. In one implementation, if the CONS ROP is not larger than the sum of the forecast over leadtime (RLT), the text “FCSTNotCoverd” may be displayed to alert the user to that condition.

In some implementations, based on the recommendation by the recommended engine, the user may choose to change the current ROP type to the recommended ROP type. If the ROP type is changed, the change may be saved by clicking on the SAVE button. As a result, the data in the database may be changed automatically. Further, in one implementation, the planning selecting component 700 may comprise a Create DB Upload File button, which may be clicked on by the user to automatically generate a file with all the changes made in the inventory optimization system.

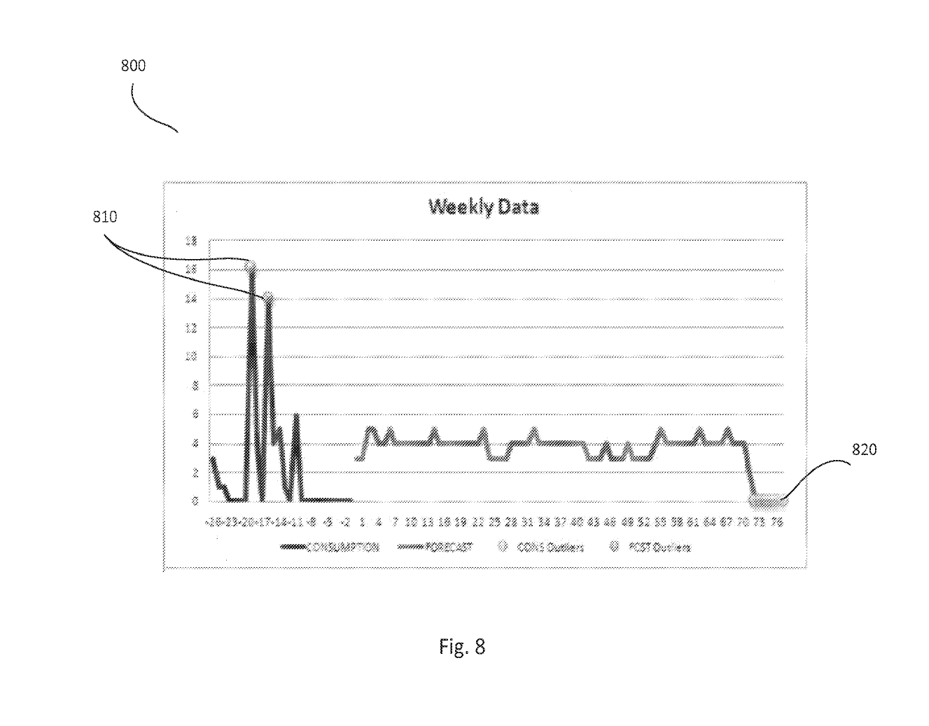

FIG. 8 illustrates an example plot 800 of the system 100 in accordance with an implementation. The plot (e.g., graph) 800 shows weekly data of consumption and forecast with outlier alerts. The consumption component comprises twenty six weeks of data, and the forecast component comprises seventy eight weeks of data. Further, the dots 810 indicate consumption outliers, and the dots 820 indicate forecast outliers. In one implementation, outliers may be determined by calculating a threshold for acceptable values and those values exceeding the threshold may be noted as outliers. In this implementation, the threshold may be determined by calculating the mean and standard deviation of the consumption data points and the threshold may be set to equal +or −3 standard deviations from the mean. Data points higher or lower than that threshold are highlighted as outliers. Similarly, forecast outliers would be determined by calculating the mean and standard deviation of the forecast data points and the threshold may be set to equal +or −3 standard deviations from the mean. Data points higher or lower than that threshold are highlighted as outliers. The number of standard deviations used to determine outliers may be user-selectable.

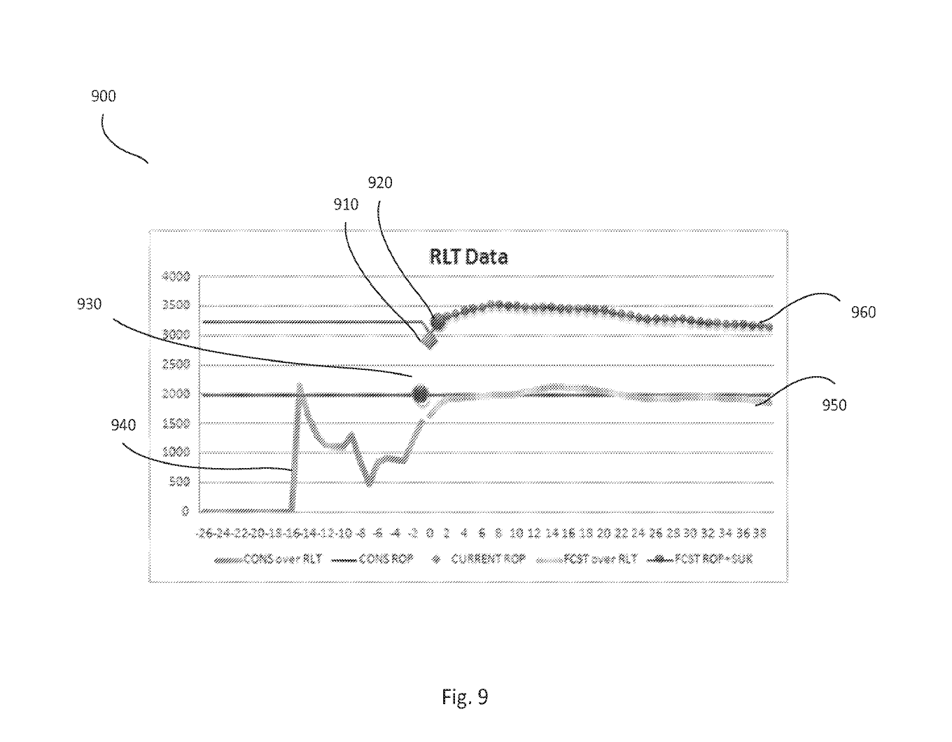

FIG. 9 illustrates an example graphical view 900 of data related to the system 100 in accordance with an implementation. The plot 900 shows replenishment lead time (RLT) data and ROP choices. Point 910 on the plot 900 displays the current ROP value. Point 930 shows the suggested consumption, and point 920 shows the suggested forecast. Line 940 presents the consumption over RLT, and line 950 presents the forecast over RLT. Line 960 represents the projected FCST ROP+SUK quantities.

FIG. 10 illustrates an example graphical view 1000 of the inventory simulation of the system 100 in accordance with an implementation. The graphical view 1000 comprises area 1010, which represents the initial ordering period when there is no stock available. Moreover, line 1020 shows the service level and may vary by each quarter. Further, line 1030 represents quantified safety stock target, which can be calculated by: TDOS*Forecast+SUK (if SUKs exist).

The graphical view 1000 further comprises area 1040, which represents end of the week available stock quantity. The end of the week available stock quantity includes all the actual and projected ending by week after projected shipments (forecast based) are considered.

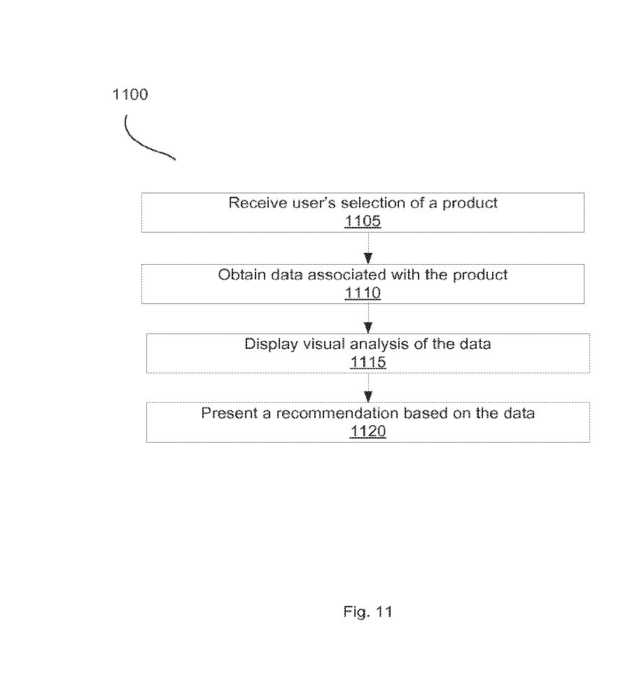

Turning now to the operation of the platform 110 of FIG. 1, FIG. 11 illustrates an example process flow diagram 1100 in accordance with an implementation. It should be readily apparent that the processes illustrated in FIG. 11 represents generalized illustrations, and that other processes may be added or existing processes may be removed, modified, or rearranged without departing from the scope and spirit of the present disclosure. Further, it should be understood that the processes may represent executable instructions stored on memory that may cause a processor to respond, to perform actions, to change states, and/or to make decisions. Thus, the described processes may be implemented as executable instructions and/or operations provided by a memory associated with the platform 110. Furthermore, FIG. 11 is not intended to limit the implementation of the described implementations, but rather the figure illustrates functional information one skilled in the art could use to design/fabricate circuits, generate software, or use a combination of hardware and software to perform the illustrated processes. Also, the various operations depicted in FIG. 11 may be performed in the order shown or in a different order and two or more of the operations may be performed in parallel instead of serially.

The process 1100 may begin at block 1105, where the user (e.g., the planner) identifies a product. In particular, this process may involve the user selecting a product from a drop down menu. In one implementation, the drop down menu may be generated based on the user's identification. If the user provides ID information, the system displays the products that are associated with such user as options on the drop down menu.

At block 1110, the system proceeds to obtain data associated with the product. In one implementation, the data comprises forecast value add, replenishment lead time (RLT), ROP type, TDOS, prior single-use kanban (SUK) entries, current, forecast, and historical consumption data related to the product. In one example, the data may be received from various components of an inventory optimization system. In other examples, the data may be pulled from a single database or may be compiled from several databases distributed across an organization and connected via a network, such as a wide area network (WAN), a storage area network (SAN), or in various data servers connected to the internet.

At block 1115, the system may generate and display visual analysis of the data. As described in greater detail in reference to FIGS. 3-10, this process may include generating various graphical representations and pivot table worksheets based on the data.

At block 1120, based on the data associated with the product, the system presents a recommendation for the user to consider in order to optimize inventory performance. In one implementation, the system may review the forecast value add value of the product, and based on the review, the system may make a ROP recommendation. In particular, if the FVA is positive, the system recommends selecting the forecast based ROP. If the FVA is negative, the system may check whether the consumer based ROP covers the forecast. In the event that the consumer based ROP does not cover the forecast, the system recommends selecting the forecast based ROP. In the event that the consumer based ROP covers the forecast, the system recommends consumer based ROP. Further, in response to the recommendation, the user may select the ROP type recommended by the system.

The present disclosure has been shown and described with reference to the foregoing exemplary implementations. It is to be understood, however, that other forms, details, and examples may be made without departing from the spirit and scope of the disclosure that is defined in the following claims. As such, all examples are deemed to be non-limiting throughout this disclosure.

1. A processor-implemented method for analyzing product data, comprising:
receiving, by at least one processor, a selection of a product from a user;
obtaining, by the at least one processor, data associated with the product, the data comprising at least different types of a parameter;
providing, by the at least one processor, visual analysis of the data; and
presenting, by the at least one processor, a recommendation based on the data.

2. The method of claim 1, further comprising updating the data based on the user's selection of the type of the parameter.

3. The method of claim 1, wherein providing visual analysis of the data comprises displaying graphics and tables.

4. The method of claim 1, wherein the parameter is re-order point, and the different types of the parameter comprises a forecast based re-order point and a historical consumption based re-order point.

5. The method of claim 1, further comprising receiving a selection input, from the user, of a type of the different types of the parameter, the selection input based on the recommendation.

6. The method of claim 5, wherein the parameter comprises re-order point, and wherein the recommendation presented to the user relates to re-order point types, and the user selects a type of re-order point based on the recommendation.

7. The method of claim 5, wherein the forecast value add is zero or above zero, the recommendation is to select a forecast based re-order point.

8. The method of claim 5, wherein the forecast value add is below zero, the recommendation is to select a historical consumption based re-order point.

9. The method of claim 5, comprising comparing value of a forecast based re-order point to value of a current re-order point, and displaying a change alert based on the comparison.

10. The method of claim 9, wherein displaying the change alert comprises displaying the change alert in response to the value of the forecast based re-order point being greater or less than the value of the current re-order point by a predetermined threshold.

11. A system comprising:
a data capturing module to collect data associated with a product, the product selected by a user and the data comprising of a product inventory level of the product;
a display module to provide visual analysis of the data, the visual analysis comprising a graphical representation and a table comprising cells, and wherein the graphical representation and the table represent the product inventory level; and
a recommendation module to provide a recommendation related to the product inventory level, wherein the recommendation is related to a parameter associated with the data.

12. The system of claim 11, further comprising at least one user interface to provide a plurality of user controllable features for modifying the data based on the recommendation.

13. The system of claim 12, wherein the modifications to the data are stored in a database.

14. A non-transitory computer-readable medium comprising instructions that when executed cause a system to:
obtain data associated with a product selected by a user, the data comprising at least one of replenishment lead time, demand over the replenishment lead time, forecast value add, or re-order point values for a plurality of re-order point types;
provide visual analysis of the data;
present a recommendation based on the data
receive a selection by the user of a type from the different types of a parameter based on the recommendation; and
update the data based on the type of the parameter selected by the user.

15. The non-transitory computer-readable medium of claim 14, further comprising instructions that when executed cause the system to:
receive a selection input of a product and user identification information from the user;
compare value of the forecast based re-order point of the product to value of current re-order point of the product; and
display a change alert based on the comparison, wherein the change alert is displayed in response to the value of the forecast based re-order point being greater or less than the value of the current re-order point by a predetermined threshold.

16. The non-transitory computer-readable medium of claim 14, wherein the recommendation is to select a forecast based re-order point in response to the forecast value add being zero or above zero.

17. The non-transitory computer-readable medium of claim 14, wherein the recommendation is to select a historical consumption based re-order point in response to the forecast value add being below zero.

18. The system of claim 11, comprising:
a processor; and
a computer readable media storing the data capturing module, the display module, and the recommendation module.

19. The system of claim 11, wherein the parameter comprises re-order point, and wherein the recommendation comprises that the user select a type of the re-order point.

20. The system of claim 11, wherein the system to review forecast value add (FVA) of the product to determine the type of the re-order point to recommend to user in the recommendation.
